(19) United States
(12) Patent Application Publication
(10) Pub. No.: US 2010/0054880 A1
(43) Pub. Date: Mar. 4, 2010

(54) AUGER BIT WITH A REMOVABLE TIP

(76) Inventor: Brian Ray, Gilbert, AZ (US)

Correspondence Address: BOOTH UDALL, PLC, 1155 W. Rio Salado Pkwy., Suite 101, Tempe, AZ, 85281, US

(21) Appl. No.: 12/198,554

(22) Filed: Aug. 26, 2008

(51) Int. Cl. B23B 51/02

(52) U.S. Cl. 408/1 BD; 408/201; 408/214; 408/230

(57) ABSTRACT

An auger bit with a removable tip is provided. The removable tip is coupled to a first end of the auger bit. The auger bit includes a second end adapted to repeatably removably couple to a drill. The removable tip may be coupled to the first end of the auger bit by a set screw. The removable tip includes a screw tip and a cutting edge. The removable tip is configured to be replaced when it is worn, particularly when one of the screw tip and the cutting edge are worn.

### BACKGROUND OF THE INVENTION

1. Technical Field

This invention relates generally to an auger bit and more particularly to an auger bit with a removable and replaceable tip.

2. State of the Art

Auger bits are bits utilized by drills to remove material from a particular substrate, commonly referred to as chip removal. Auger bits are helical in design with flutes extending along the length in order to properly move the material being cut out of the hole that the auger bit is creating. Auger bits commonly have a cutting edge at an end along with a self-feeding screw tip.

Auger bits have two common areas of wear. The first is the self-feeding screw tip and the second is the cutting edge. The reason for the greater wear on these components is that the screw tip and the cutting edge are the components of the auger bit that contact the substrate in order to create chips for removal. The rest of the auger bit is simply to remove the chips created by the cutting edge.

Conventionally, in order to overcome the wear on the auger bit cutting edge and screw tip, a user must replace the entire auger bit. Regardless of the fact that the rest of the auger bit is in proper functional condition, the main cutting components are worn and the bit becomes ineffective.

Accordingly, there is a need in the filed of auger bits for an auger bit that has a removable replaceable tip in order to replace the cutting edge and screw tip.

### DISCLOSURE OF THE INVENTION

The present invention relates to an auger bit with a removable tip coupled to a first end of an auger bit and a second end of the auger bit adapted to repeatably removably couple to a drill. The removable tip may be removed when worn and replaced with a new removable tip. The tip may be replaced until the rest of the auger bit reaches a wear condition that requires a new auger bit.

An aspect of the present invention includes a removable tip coupled to a first end of an auger bit; and a second end of the auger bit adapted to repeatably removably couple to a drill. The auger bit may further comprise a set screw adapted to couple the removable tip to the auger bit wherein the removable tip is configured to be replaced when it is worn.

Another aspect of the present invention includes a method of using an auger bit with a replaceable tip. The method comprises securing a removable tip to an auger bit; coupling the auger bit to a drill; and operating the auger bit in response to operation of the drill. The method may further comprise wearing down the removable tip, removing the worn removable tip and securing another removable tip to the auger bit.

Yet another aspect of the invention includes an auger comprising a drill, an auger bit having a first end and an opposing second end, the second end removably coupled to the drill and a removable tip coupled to the first end of the auger bit.

The foregoing and other features and advantages of the present invention will be apparent from the following more detailed description of the particular embodiments of the invention, as illustrated in the accompanying drawings.

### BRIEF DESCRIPTION OF THE DRAWINGS

The invention will hereinafter be described in conjunction with the appended drawings where like designations denote like elements, and:

FIG. 1 is a perspective view of an auger bit with a removable tip;

FIG. 2 is an exploded view of a portion of an auger bit with a removable tip;

FIG. 3 is a perspective view of a first end of an auger bit with a removable tip;

FIG. 4 is a perspective view of an auger having a drill and an auger bit with a removable tip; and

FIG. 5 is a method of using an auger bit with a removable tip in accordance with the present invention.

### DETAILED DESCRIPTION OF EMBODIMENTS OF THE INVENTION

As discussed above, embodiments of the present invention relate to an auger bit with a removable tip coupled to a first end of an auger bit and a second end of the auger bit adapted to repeatably removably couple to a drill. The removable tip may be removed when worn and replaced with a new removable tip. The tip may be replaced until the rest of the auger bit reaches a wear condition that requires a new auger bit.

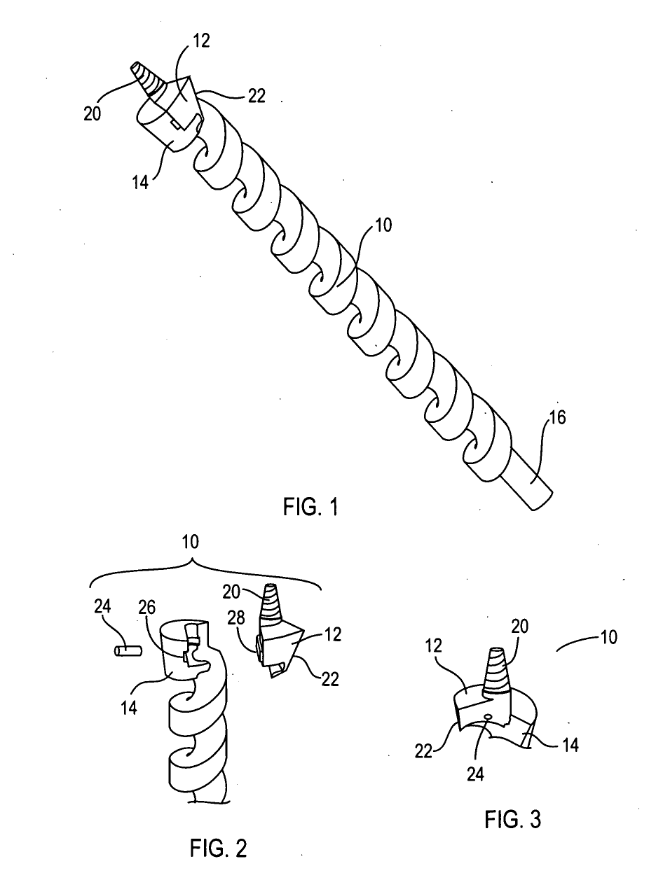

Referring to the drawings, FIGS. 1-3 depict an auger bit 10 in accordance with particular embodiments of the present invention. The auger bit 10 may include a removable tip 12. The auger bit 10 further includes a first end 14 and a second end 16. The removable tip 12 is coupled to the first end 14 of the auger bit 10. The second end 16 of the auger bit 12 is adapted to couple to a drill. The removable tip includes a screw tip 20 and a cutting edge 22.

The removable tip 12 may be coupled to the first end 16 of the auger bit 10 in many ways. One such way depicted in the figures is by use of a set screw 24. While a set screw is shown, other means of removably coupling the removable tip 12 to the auger bit 10 may be utilized without departing from the scope of the claims of the present invention.

The removable tip 12 may be configured to be replaced when it is worn. In particular, the removable tip 12 is replaceable when one of the screw tip 20 and the cutting edge 22 are worn. A new removable tip 12 may replace the worn removable tip 12 and the auger bit 10 may be used again.

Particular embodiments of the present invention include the auger bit 10 comprising a channel 26 formed in the first end 14 of the auger bit 10. The removable tip 12 may further comprise a protrusion 28 corresponding to the channel, wherein the protrusion 28 is coupled within the channel 26 when the removable tip 12 is coupled to the auger bit 10.

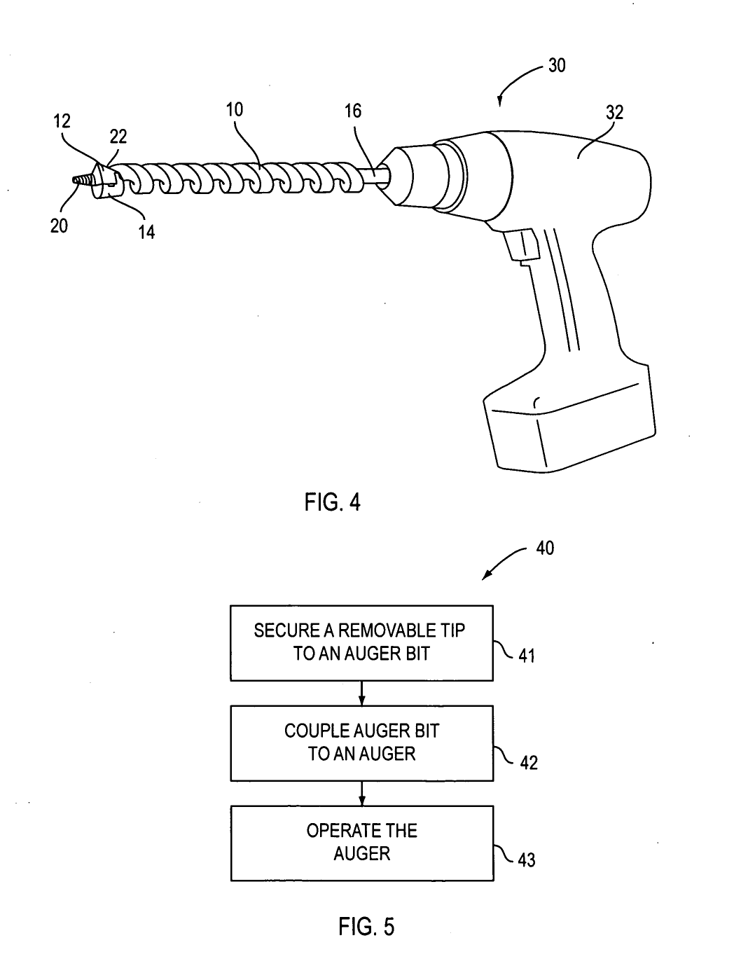

Referring again to the drawings, FIG. 4 depicts an auger 30 in accordance with embodiments of the present invention. The auger 30 includes a drill 32 and an auger bit 10. The auger bit 10 further includes a removable tip 12 having a screw tip 20 and a cutting edge 22. The auger bit 10 is the same auger bit as described above having the same components and function. It will be understood that the auger 30 may be utilized in operation to remove material from a substrate and the auger bit 10 operates in a similar fashion to conventional auger bits, with the ability to replace the tip 12 when it is worn.

Referring again to the drawings and in accordance with embodiments of the invention, FIG. 5 depicts a method 40 of using an auger bit with a removable tip. The method may include the steps of securing a removable tip to an auger bit (Step 41); coupling the auger bit to a drill (Step 42); and operating the auger bit in response to operation of the drill (Step 43). The method 40 may further comprise wearing down the removable tip and removing the worn removable tip. The method 40 may also include the step of securing another removable tip to the auger bit. Additionally, embodiments of the present invention may include as part of method 40 a step of repeating the method 100 until the auger bit requires replacement.

Accordingly, the components defining any auger bit with a removable tip may be formed of any of many different types of materials or combinations thereof that can readily be formed into shaped objects provided that the components selected are consistent with the intended operation of an auger bit. For example, the components may be formed of: rubbers (synthetic and/or natural) and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any auger bit with a removable tip may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An auger bit comprising:
a removable tip coupled to a first end of an auger bit; and
a second end of the auger bit adapted to repeatably removably couple to a drill.

2. The auger bit of claim 1, further comprising a set screw adapted to couple the removable tip to the auger bit.

3. The auger bit of claim 1, wherein the removable tip is configured to be replaced when it is worn.

4. The auger bit of claim 3, wherein the removable tip comprises a screw tip and a cutting edge.

5. The auger bit of claim 4, wherein the removable tip is replaceable when one of the screw tip and the cutting edge are worn.

6. The auger bit of claim 1, further comprising a channel formed in the first end of the auger bit.

7. The auger bit of claim 6, wherein the removable tip further comprises a protrusion corresponding to the channel, wherein the protrusion is coupled within the channel when the removable tip is coupled to the auger bit.

8. A method of using an auger bit with a replaceable tip; the method comprising:
securing a removable tip to an auger bit;
coupling the auger bit to a drill; and
operating the auger bit in response to operation of the drill.

9. The method of claim 8, further comprising wearing down the removable tip.

10. The method of claim 9, further comprising removing the worn removable tip.

11. The method of claim 10, further comprising securing another removable tip to the auger bit.

12. The method of claim 11, further comprising repeating the method until the auger bit requires replacement.

13. An auger comprising:
a drill;
an auger bit having a first end and an opposing second end, the second end removably coupled to the drill; and
a removable tip coupled to the first end of the auger bit.

14. The auger of claim 13, wherein the auger bit further comprises a set screw adapted to couple the removable tip to the auger bit.

15. The auger of claim 13, wherein the removable tip is configured to be replaced when it is worn.

16. The auger of claim 15, wherein the removable tip comprises a screw tip and a cutting edge.

17. The auger bit of claim 16, wherein the removable tip is replaceable when one of the screw tip and the cutting edge are worn.

18. The auger of claim 13, wherein the auger bit further comprises a channel formed in the first end of the auger bit.

19. The auger bit of claim 18, wherein the removable tip further comprises a recess corresponding to the channel, wherein the recess is coupled within the channel when the removable tip is coupled to the auger bit.
